(19) United States
(12) Patent Application Publication
(10) Pub. No.: US 2002/0081058 A1
(43) Pub. Date: Jun. 27, 2002

(54) Optical cross-connect for optional interconnection of communication signals of different multiplex levels

(75) Inventors: Werner Beisel, Ludwigsburg (DE); Volker Hagele, Schorndorf (DE); Heinz Wettengel, Ditzingen (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/020,179

(22) Filed: Dec. 18, 2001

(30) Foreign Application Priority Data
Dec. 23, 2000 (DE) 100 64 990.4

(51) Int. Cl. G02B 6/35

(52) U.S. Cl. 385/17; 385/16

(57) ABSTRACT

An optical cross-connect (OCX), which is designed for the switching of so-called Optical Channels of different multiplex levels with respectively defined bit rates, has a number of input/output ports (I/O) which are respectively adapted to transmit and receive communication signals of a particular multiplex level, and a switching matrix (S) which is connected to the input/output ports (I/O). The switching matrix (S) is a space switching matrix which is transparent for communication signals of all multiplex levels. In order to provide the interface between the individual multiplex levels, the cross-connect (OCX) has at least one multiplexer (MUX), which is also connected to the switching matrix (S). This multiplexer (MUX) is adapted to multiplex a number of communication signals of a lower multiplex level that are received from the switching matrix (S), so as to form a communication signal of a higher multiplex level, and return this to the switching matrix (S), as well as to demultiplex a communication signal of a higher multiplex level that is received from the switching matrix (S), so as to form a number of communication signals of a lower multiplex level, and return these individually to the switching matrix (S).

The invention is based on a priority application DE 10064990.4, which is incorporated by reference herein.

### FIELD OF THE INVENTION

The invention relates to the field of telecommunications and more particularly to an optical cross-connect for switching connections in an optical transmission network, in which optical communication signals of different multiplex levels with respectively defined bit rates can be transmitted, communication signals of a higher multiplex level being composed of communication signals of a lower multiplex level or directly containing a payload data signal.

### BACKGROUND OF THE INVENTION

In optical communication transmission, synchronous optical systems are currently used which are known in Europe as SDH (synchronous digital hierarchy) and in North America as SONET (synchronous optical network) systems. These systems define communication signals of different hierarchy levels, with communication signals of a higher multiplex level being composed of communication signals of a lower multiplex level or directly containing a payload data signal. The multiplex hierarchy of these systems is defined in ITU-T G.707, Chapter 6. An overview of these systems is presented in, for example, the article “SONET 101” by the Nortel Networks company, which can be downloaded from the Internet address www.nortel.com/broadband/pdf/sonet_{—}101.pdf.

In optical communication transmission networks, cross-connects are used which have the function of establishing paths in the network. For this purpose, it is necessary to be able to switch multiplex units from each input to each output. Known in the art are so-called 4/3/1 cross-connects such as, for example, the 1641SX of the Alcatel company, which are able to switch multiplex units of all hierarchy levels (VC-4, VC3, VC-12 in the case of SDH) from each input to each output. In addition, there are also so-called 4/4 cross-connects such as, for example, the 1664SX of the Alcatel company, which are adapted for switching only multiplex units of the highest hierarchy level (in the case of SDN VC-4). The main item of this cross-connect is a space/time switching matrix which is connected to all input/output ports. In the case of the known systems, this switching matrix is in the form of a three-stage electrical switching matrix after Clos (see Clos, “A Study of Non-Blocking Switching Networks”, B.S.T.J. No. 32, 1953, pp. 406-424).

In addition, so-called optical cross-connects are currently being developed which are intended to switch optical communication signals of any format, such as SONET, ATM and IP. They comprise a central space switching matrix which is to be transparent to the communication signals to be switched. An example of such an optical cross-connect is presented in the article “Cost Effective Optical Networks: The Role of Optical Cross-Connects”, by Charles A. Brackett, which can be downloaded from the Internet site www.tellium.com.

More recent developments in optical communication transmission are directed at transmitting communication signals of increasingly higher bit rates. Thus, a new multiplex hierarchy known as “optical channel (OCh)” is currently under discussion. This new multiplex hierarchy is intended to have multiplex levels with bit rates of 2.66 Gbit/sec. and multiples (factor four) of that rate, namely, 10.7x Gbit/sec. and 43.x Gbit/sec. The future optical channels are intended, in particular, for optical communication transmission in wavelength division multiplex (WDM). This system is referred to as Optical Transport Network (OTN) and standardized in ITU-T G.709 (2001), which is incorporated by reference herein.

These optical channels also require cross-connects which are capable of switching communication signals of all hierarchy levels from each input to each output. For the switching matrix of such cross-connects, the approach with a three-stage electrical space/time matrix after Clos cannot be achieved at a warrantable cost, due to the high bit rate. Optical cross-connects with a transparent space switching matrix, however, are not capable of connecting ports for communication signals of a higher multiplex level to ports for communication signals of a lower multiplex level. On the other hand, such optical cross-connects are far from cost effective for the new optical channels.

### SUMMARY OF THE INVENTION

The object of the invention, therefore, is to provide a cross-connect for optical channels which supports full connectivity for communication signals of all multiplex levels. A further object of the invention is to disclose a method for switching optical channels of different multiplex levels.

The object is achieved by a cross-connect which is designed for the switching of so-called Optical Channels of different multiplex levels with respectively defined bit rates. The cross-connect has a number of input/output ports which are respectively adapted to transmit and receive communication signals of a particular multiplex level, and a switching matrix which is connected to the input/output ports. The switching matrix is a space switching matrix which is transparent for communication signals of all multiplex levels. In order to provide the interface between the individual multiplex levels, the cross-connect has at least one multiplexer, which is also connected to the switching matrix. This multiplexer (MUX) is adapted to multiplex a number of communication signals of a lower multiplex level that are received from the switching matrix, so as to form a communication signal of a higher multiplex level, and return this to the switching matrix, as well as to demultiplex a communication signal of a higher multiplex level that is received from the switching matrix, so as to form a number of communication signals of a lower multiplex level, and return these individually to the switching matrix.

Advantageous refinements can be found in the dependent claims.

### BRIEF DESCRIPTION OF THE DRAWINGS

The invention will be explained in more detail below in an exemplary embodiment with reference to FIGS. 1 and 2, in which:

FIG. 1 shows the schematic structure of an optical cross-connect, and

FIG. 2 shows the structure of the cross-connect according to the invention.

### DETAILED DESCRIPTION OF THE INVENTION

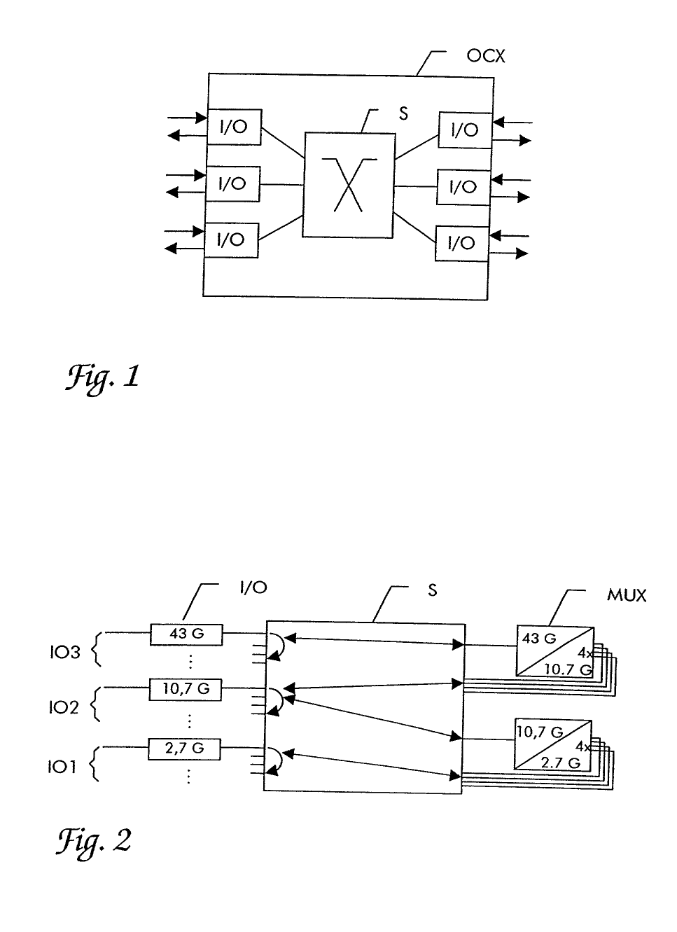

FIG. 1 presents the usual design of a cross-connect OCX. It comprises a number of optical input/output ports I/O, all of which are connected to a switching matrix S. The switching matrix S can thus switch each input to any output. In the case of known 4/3/1 cross-connects for SDH, the matrix is a space/time switching matrix which can switch any multiplex units, down to the lowest multiplex level, from any inputs to any outputs. In the case of known optical cross-connects, the switching matrix is a space switching matrix which is transparent to any signal formats. In these cases, however, only inputs of the same kind can be switched to outputs of the same kind. Thus, there would be no point in switching an ATM input to an STM-64 output, or the reverse.

According to the invention, the input/output ports I/O for communication signals are designed according to the definition of the optical channel (OCh,). These are based on a basic bit rate of 2.66 Gbit/sec., higher multiplex levels having four times the bit rate of the basic bit rate. Communication signals of a higher multiplex level are formed through byte-embedding of four communication signals of the respectively next-lower multiplex level, or directly contain a payload data signal. In the multiplexing of communication signals of a lower multiplex level to form a communication signal of a next-higher multiplex level, byte-stuffing is used to equalize frequency differences of the sub-signals. Hitherto, provision has been made for two higher multiplex levels, with bit rates of 10.7x Gbit/sec. and 43.x Gbit/sec. The exact bit rate has not yet been finally determined, so that the final effective bit rate position is denoted by x. It is assumed that further, higher multiplex levels will be determined in future.

A basic concept of the invention consists in using a space switching matrix, to which a multiplexer is linked. Communication signals which are to be switched to an output of the same multiplex level are switched directly by the switching matrix to the respective output, whereas communication signals which are to be switched to an output of a lower or higher multiplex level are firstly switched by the switching matrix to the multiplexer, where they are multiplexed or demultiplexed, then returned to the switching matrix which then switches the multiplexed or demultiplexed communication signals to the relevant output port. The multiplexers hence provide the interface between the multiplex levels.

Such a cross-connect is represented in FIG. 2. It has a series of input/output ports I/O for optical communication signals of different multiplex levels. The ports I/O are all connected to the space switching matrix S. Two multiplexers MUX are also connected to the space switching matrix S. One of the multiplexers is provided for multiplexing communication signals of the lowest multiplex level so as to form communication signals of the second, middle multiplex level, and for the corresponding demultiplexing. The other multiplexer is provided for multiplexing communication signals of the second multiplex level so as to form communication signals of the highest multiplex level, and for the corresponding demultiplexing.

Each of the two multiplexers has four ports for communication signals of the respective lower multiplex level, and one port for communication signals of the higher multiplex level. All five of these ports are connected to ports of the space switching matrix S.

The input/output ports I/O of the cross-connect can be subdivided into three groups: a first group of ports IO1 for communication signals of the lowest multiplex level, with a bit rate of 2.66 Gbit/sec, a second group of ports IO2 for communication signals of the second multiplex level, with a bit rate of 10.7x Gbit/sec, and a third group of ports IO3 for communication signals of the highest multiplex level, with a bit rate of 43.x Gbit/sec.

The function of the cross-connect is as follows: the switching matrix switches connections at all multiplex levels from any inputs to any outputs. The switching state of the matrix is in this case determined by a control device (not shown) via a network management system.

Communication signals with a bit rate of 2.66 Gbit/sec are received at the ports of the first group IO1. If a communication signal is to be switched from such a port to a port of the same type in the same group IO1, then the switching matrix switches this communication signal directly to the relevant port. Likewise, communication signals at the ports of the groups IO2 and IO3 are switched directly to the relevant ports, when these belong to the same group. Otherwise, conversion must take place in one of the multiplexers MUX.

The case in which a communication signal of the lowest multiplex level (2.66 Gbit/sec) is to be switched from a port of the first group IO1 to a port of the second group IO2, will now be assumed as an example. To that end, the 2.66 Gbit/sec communication signal is switched by the switching matrix to the lower of the two multiplexers MUX shown. As mentioned above, the multiplexer MUX has four ports for communication signals of the lowest multiplex level, and one port for signals of the middle multiplex level. The multiplexer interleaves the communication signals received at the four ports of the lowest multiplex level byte-wise so as to form a communication signal of the middle multiplex level, and returns this to the switching matrix S. This interleaved communication signal is then switched by the switching matrix S to the relevant output of the middle multiplex level. If the 2.66 Gbit/sec communication signal (described as an example) is the only communication signal which is to be switched to the relevant output, then the multiplexer interleaves it with three empty signals in order to form the communication signal of the middle multiplex level.

All switching states of the matrix and the operating modes of the multiplexers are bidirectional. For example, a communication signal from a port of the middle multiplex level can hence be switched via the switching matrix S to the corresponding port of the lower multiplexer MUX. The latter demultiplexes the signal so as to form four communication signals of the lowest multiplex level, and returns this to the switching matrix S. The switching matrix S then switches these four communication signals to four different ports of the first group IO1.

If a communication signal of the lowest multiplex level is to be switched from a port of the first group IO1 to a port of the third group IO3, then it is firstly switched by the switching matrix to the lower multiplexer MUX: the latter then forms, with three other communication signals or also optionally with empty signals, a communication signal of the middle multiplex level which is then returned to the switching matrix S. The switching matrix S then switches this multiplexed communication signal of the middle multiplex level to the upper multiplexer which, in turn with three other communication signals of the middle multiplex level or also optionally with empty signals, forms a communication signal of the highest multiplex level by byte-wise interleaving of the four signals. The communication signal of the highest multiplex formed in this way is then switched by the switching matrix S to the relevant output of the third group.

The switching matrix can be embodied either as an electrical switching matrix or as an optical switching matrix. In the case of an electrical switching matrix, it is advantageously configured for parallel signal processing, i.e. it contains for example eight parallel paths for the eight bits of each byte of the communication signals to be switched. This is necessary since switching matrices for at most 20 Gbit/sec can be constructed with state-of-the-art integrated semiconductor circuits produced on the basis of SiGe technology. An optical switching matrix may be constructed, for example, by using small mirrors, referred to as micro-mirrors. The switching matrix is preferably transparent for the communication signals of all multiplex levels.

The use of two multiplexers is not intended to represent any limitation of the invention. Instead, a plurality of multiplexers of the same type may also be joined simultaneously to the switching matrix S. This is advantageous in the case of large switching matrices having a switching capacity of several dozen communication signals, so that a plurality of quartets of ports of a lower multiplex level can be connected simultaneously to ports of a higher multiplex level.

The cross-connect according to the invention is advantageously constructed modularly in the form of plug-in circuit boards. It can therefore be expanded flexibly, e.g. by adding further plug-in multiplexer circuit boards and plug-in matrix circuit boards.

What is claimes is:

1. An optical cross-connect for switching connections in an optical transmission network, in which optical communication signals of different multiplex levels with respectively defined bit rates can be transmitted, communication signals of a higher multiplex level being composed of communication signals of a lower multiplex level or directly containing a payload data signal; the cross-connect containing:
a number of input/output ports which are respectively adapted for transmitting and receiving communication signals of a particular multiplex level, and
a switching matrix connected to the input/output ports, wherein the switching matrix is a space switching matrix, and wherein at least one multiplexer also connected to the switching matrix is provided, which is adapted to multiplex a number of communication signals of a lower multiplex level that are received from the switching matrix, so as to form a communication signal of a higher multiplex level, and return this to the switching matrix, as well as to demultiplex a communication signal of a higher multiplex level that is received from the switching matrix, so as to form a number of communication signals of a lower multiplex level, and return these individually to the switching matrix.

2. An optical cross-connect according to claim 1, in which the switching matrix is a transparent space switching matrix.

3. An optical cross-connect according to claim 2, in which the switching matrix is an optical space switching matrix.

4. An optical cross-connect according to claim 2, in which the switching matrix is an electrical space switching matrix.

5. An optical cross-connect according to claim 1, in which ports for a lowest hierarchy level, with a bit rate of 2.66 Gbit/sec, and two higher hierarchy levels, each with four times the bit rate of the hierarchy level immediately below, are respectively provided, and in which two multiplexers are linked to the switching matrix, the first multiplexer being adapted to multiplex four communication signals of the lowest hierarchy level so as to form one communication signal of the middle hierarchy level, and vice versa, and the second multiplexer being adapted to multiplex four communication signals of the middle hierarchy level so as to form one communication signal of the highest hierarchy level, and vice versa.

6. An optical cross-connect according to claim 1, in which the subassemblies are embodied modularly in the form of plug-in circuit boards.

7. A method for switching optical communication signals of different multiplex levels with respectively defined bit rates, communication signals of a higher multiplex level being composed of communication signals of a lower multiplex level or directly containing a payload data signal, with the steps:
receiving of an optical communication signal;
sending the communication signal to a switching matrix;
identifying the hierarchy level of the communication signal;
identifying the output to which the communication signal is to be switched;
if the communication signal is to be switched to an output which supports the same hierarchy level, switching the communication signal to the respective output;
if the communication signal is to be switched to an output which supports a higher hierarchy level,
switching the communication signal to a multiplexer,
multiplexing the communication signal so as to form a communication signal of the higher hierarchy level,
returning the multiplexed communication signal to the switching matrix,
switching the communication signal to the relevant output; and
if the communication signal is to be switched to an output which supports a lower hierarchy level,
switching the communication signal to a multiplexer,
demultiplexing the communication signal so as to form a communication signal of the lower hierarchy level,
returning the demultiplexed communication signal to the switching matrix, and
switching one of the demultiplexed communication signals to the relevant output.
